(19) United States
(12) Patent Application Publication
(10) Pub. No.: US 2008/0143934 A1
(43) Pub. Date: Jun. 19, 2008

(54) LIQUID CRYSTAL DISPLAY AND METHOD OF MANUFACTURING THEREOF

(75) Inventors: Hyeong-jun PARK, Cheonan-si (KR); Byeong-jae AHN, Suwon-si (KR); Beom-jun KIM, Seoul (KR); Sung-man KIM, Seoul (KR); Hong-woo LEE, Cheonan-si (KR); Jong-hyuk LEE, Seoul (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 11/956,437

(22) Filed: Dec. 14, 2007

(30) Foreign Application Priority Data
Dec. 15, 2006 (KR) 10-2006-0128963

(51) Int. Cl. G02F 1/1335

(52) U.S. Cl. 349/106

(57) ABSTRACT

A liquid crystal display (“LCD”) capable of preventing or substantially reducing migration of impurities in a liquid crystal layer, thereby preventing or substantially reducing an occurrence of line afterimages that may be caused by the impurities, includes gate lines and data lines intersecting on an insulating substrate, pixels arranged in a matrix shape, color organic films formed on the insulating substrate and corresponding to the pixels, and indentations or other formations formed between adjacent color organic films.

This application claims priority to Korean Patent Application No. 10-2006-0128963, filed on Dec. 15, 2006, and all the benefits accruing therefrom under 35 U.S.C. §119, the contents of which in its entirety are herein incorporated by reference.

### BACKGROUND OF THE INVENTION

1. Field of the Invention

The present invention relates to a liquid crystal display (“LCD”) and a method thereof, and more particularly, to an LCD capable of preventing migration of impurities in a liquid crystal layer, thereby preventing an occurrence of line afterimages that may be caused by the impurities, and a method of manufacturing the LCD.

2. Description of the Related Art

A liquid crystal display (“LCD”) device is one of the most commonly used flat panel display (“FPD”) devices. The LCD includes two panels having a plurality of electrodes thereon and a liquid crystal layer interposed therebetween. When a voltage is applied to the electrodes, an electric field is generated between the electrodes of the two panels to modulate a transmittance of light passing through the liquid crystal layer by rearranging liquid crystal molecules to thereby display images.

An LCD includes a common electrode panel provided with a common electrode and a thin film transistor (“TFT”) array panel provided with a TFT array. The common electrode panel and the TFT array panel are opposed to each other with a liquid crystal layer interposed therebetween. The LCD controls the transmittance of incident light by applying voltages to the electrodes to rearrange liquid crystal molecules of the liquid crystal layer, to thereby display images. However, the LCD is not a self-emitting device, and thus emission of light is not spontaneous and a backlight is required as a light source. Accordingly, a backlight unit is provided on a lower portion of the TFT array panel.

In such an LCD, a reduction in aperture ratio due to a mis-alignment between a common electrode panel and a TFT panel, etc. has been addressed. Thus, in order to increase the aperture ratio of an LCD, an LCD having a color filter on array (“COA”) structure in which a color organic film is disposed on a TFT panel has been developed.

However, in an LCD having a COA structure, the formation of a passivation layer on an organic film is omitted since a color organic film is formed to be thick, and thus, impurities released from the color organic film may migrate under the influence of the electric field and may partially agglutinate, thereby causing afterimages.

### BRIEF SUMMARY OF THE INVENTION

The present invention provides a liquid crystal display (“LCD”) capable of preventing or substantially reducing migration of impurities in a liquid crystal layer, thereby preventing or substantially reducing an occurrence of line afterimages that may be caused by the impurities.

The present invention also provides a method of manufacturing the LCD.

According to exemplary embodiments of the present invention, an LCD includes gate lines and data lines intersecting on an insulating substrate, pixels arranged in a matrix shape color organic films formed corresponding to the pixels, and indentations formed between at least some adjacent color organic films.

According to other exemplary embodiments of the present invention, there is provided an LCD including gate lines and data lines intersecting on an insulating substrate, pixels arranged in a matrix shape, color organic films formed corresponding to the pixels, and protrusions formed between adjacent color organic films to overlap with the gate lines.

According to still other exemplary embodiments of the present invention, an LCD includes gate lines and data lines intersecting on an insulating substrate, pixels arranged in a matrix shape, color organic films formed corresponding to the pixels, and protrusions formed between adjacent color organic films of a same color.

According to still other exemplary embodiments of the present invention, an LCD includes gate lines and data lines intersecting on an insulating substrate, pixels arranged in a matrix shape, color organic films formed on the insulating substrate and corresponding to the pixels, and formations disposed between adjacent color organic films, each of the formations including one of an indentation and a protrusion.

According to yet other exemplary embodiments of the present invention, a method of manufacturing an LCD includes forming gate lines and data lines intersecting on an insulating substrate, arranging pixels in a matrix shape, disposing color organic films on the insulating substrate and corresponding to the pixels, and creating formations between adjacent color organic films to at least substantially prevent migration of impurities from the color organic films to a liquid crystal layer of the LCD.

### BRIEF DESCRIPTION OF THE DRAWINGS

The above and other aspects, features and advantages of the present invention will become more apparent by describing in more detail exemplary embodiments thereof with reference to the accompanying drawings in which:

FIG. 1A is a layout view illustrating an exemplary liquid crystal display (“LCD”) according to a first exemplary embodiment of the present invention;

FIG. 1B is an enlarged partial view of part “A” of the exemplary LCD of FIG. 1A;

FIG. 2A is a sectional view taken along line IIa-IIa′ of the exemplary LCD of FIG. 1A;

FIG. 2B is a sectional view taken along line IIb-IIb′ of the exemplary LCD of FIG. 1A;

FIG. 2C is a sectional view taken along line IIc-IIc′ of the exemplary LCD of FIG. 1A;

FIG. 3 is a sectional view taken along line IIb-IIb′ of the exemplary LCD of FIG. 1A, according to a modified embodiment of FIG. 2B;

FIG. 4A is a layout view illustrating an exemplary LCD according to a second exemplary embodiment of the present invention;

FIG. 4B is an enlarged partial view of part “B” of the exemplary LCD of FIG. 4A;

FIG. 5 is a sectional view taken along line V-V′ of the exemplary LCD of FIG. 4A;

FIG. 6 is a sectional view taken along line V-V′ of the exemplary LCD of FIG. 4A, according to a modified embodiment of FIG. 5;

FIG. 7A is a layout view illustrating an exemplary LCD according to a third exemplary embodiment of the present invention;

FIG. 7B is an enlarged partial view of part “C” of the exemplary LCD of FIG. 7A;

FIG. 8A is a sectional view taken along line VIIIa-VIIIa′ of the exemplary LCD of FIG. 7A; and

FIG. 8B is a sectional view taken along line VIIIb-VIIIb′ of the exemplary LCD of FIG. 7A.

### DETAILED DESCRIPTION OF THE INVENTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

The present invention will now be described more fully with reference to the accompanying drawings.

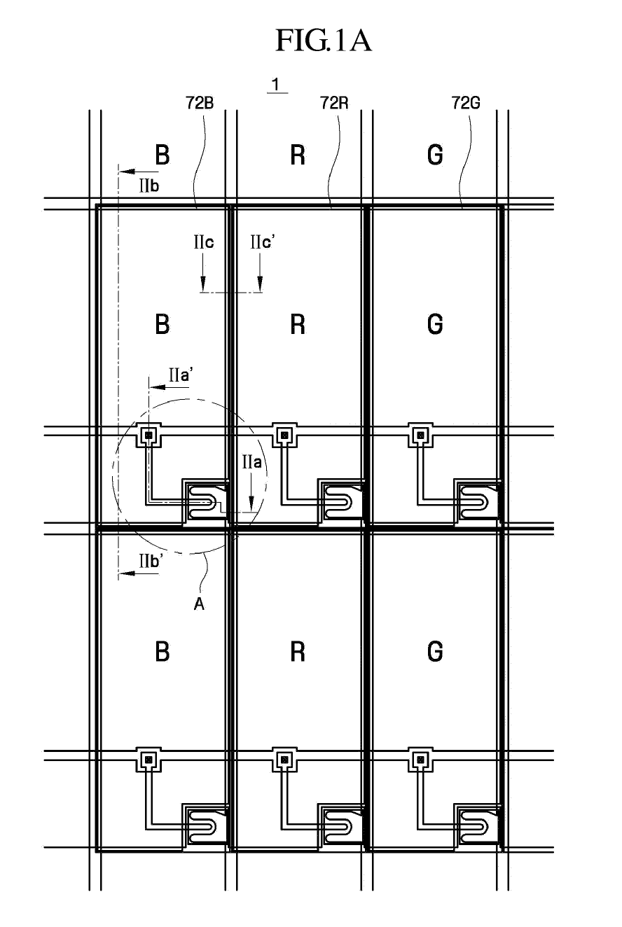

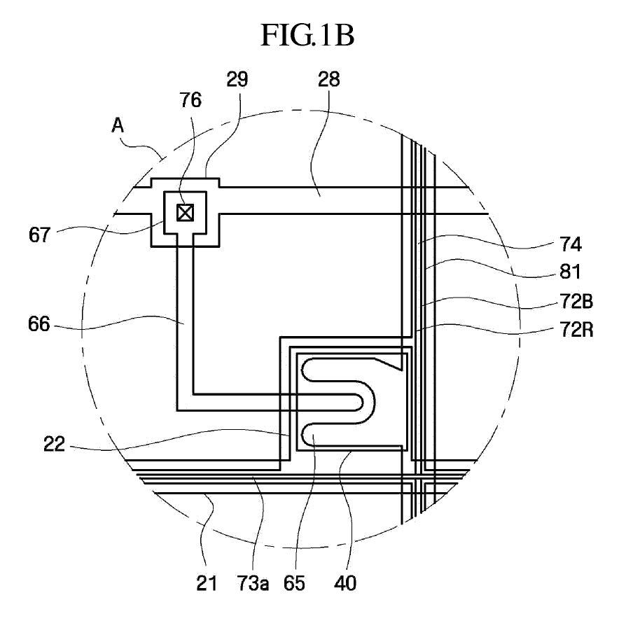

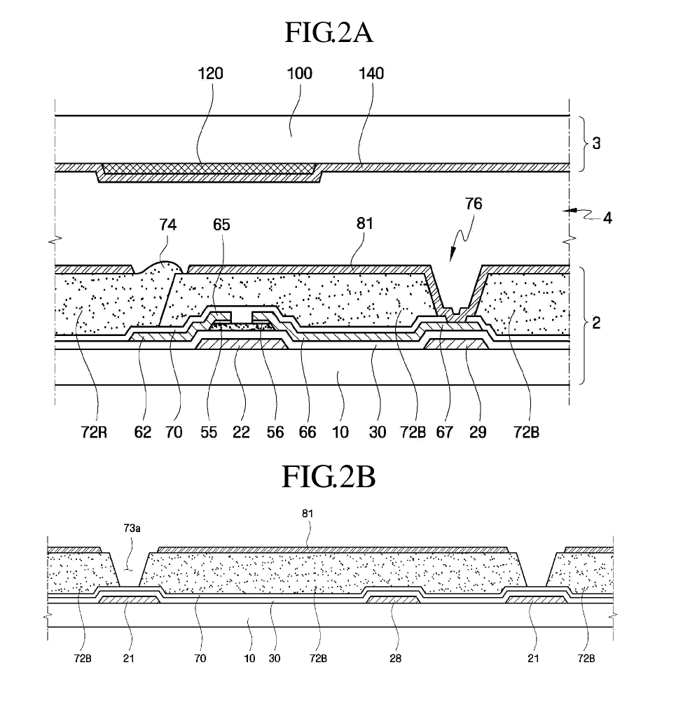

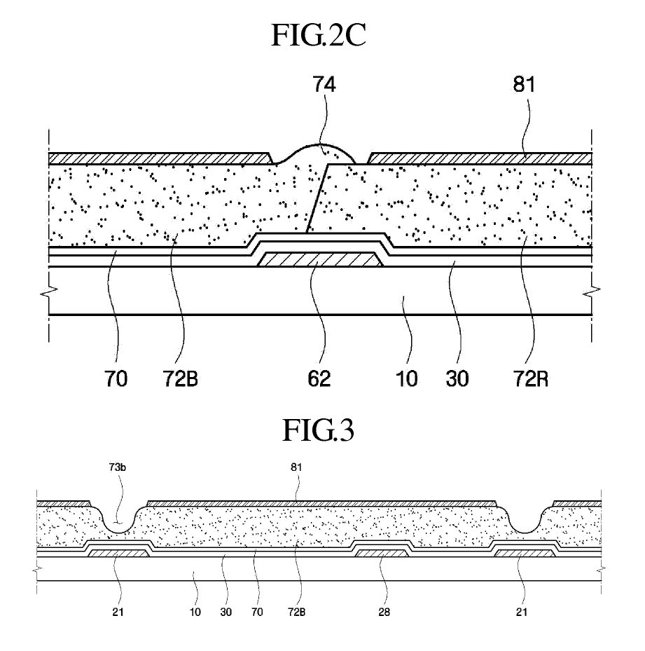

An exemplary liquid crystal display (“LCD”) 1 according to a first exemplary embodiment of the present invention will now be described in detail with reference to FIGS. 1A through 2C. FIG. 1A is a layout view illustrating an exemplary LCD 1 according to a first exemplary embodiment of the present invention, FIG. 1B is an enlarged partial view of part “A” of the exemplary LCD 1 of FIG. 1A, FIG. 2A is a sectional view taken along line IIa-IIa′ of the exemplary LCD 1 of FIG. 1A, FIG. 2B is a sectional view taken along line IIb-IIb′ of the exemplary LCD 1 of FIG. 1A, and FIG. 2C is a sectional view taken along line IIc-IIc′ of the exemplary LCD 1 of FIG. 1A.

The exemplary LCD 1 according to a first exemplary embodiment of the present invention includes a liquid crystal panel including a common electrode panel 3, a thin film transistor (“TFT”) array panel 2, a liquid crystal layer 4, a backlight assembly (not shown), which supplies light to the liquid crystal panel, and so on.

The TFT array panel 2 includes transistors formed on a first insulating substrate 10 using thin films, formed by, for example, vacuum deposition, the transistors serving as switching elements to apply electric signals to liquid crystals. The TFT array panel 2 includes a gate wire 21, 22, a data wire 62, 65, 66, red (R), green (G), and blue (B) color organic films 72R, 72G, 72B, and a pixel electrode 81.

The common electrode panel 3, together with the pixel electrode 81, creates an electric field to allow light supplied from the backlight assembly to implement image display through the R, G, and B color organic films 72R, 72G, 72B provided on the TFT array panel 2. The common electrode panel 3 includes a black matrix 120, which prevents or substantially reduces light leakage, and a common electrode 140, which is a transparent electrode for applying a voltage to liquid crystal cells in the liquid crystal layer 4.

The backlight assembly serves to supply light to the liquid crystal panel. Such a backlight assembly is classified into two types of backlight assemblies, an edge type and a direct type, according to the arrangement of lamps or other sources of light. In an edge type backlight assembly, the lamps are disposed adjacent to a side surface of a light guide plate. In a direct type backlight assembly, the lamps are disposed below a diffusing plate.

Hereinafter, the TFT array panel 2 of the exemplary LCD 1 according to the first exemplary embodiment of the present invention will now be described in more detail with reference to FIGS. 1A, 1B, and 2A.

The TFT array panel 2 includes the gate wire 21, 22 and a storage electrode wire 28, 29 formed on the first insulating substrate 10, a gate insulating layer 30, a semiconductor layer 40, an ohmic contact layer 55, 56, the data wire 62, 65, 66, the R, G, B color organic films 72R, 72G, 72B, and the pixel electrode 81.

The first insulating substrate 10 is made of a material having heat resistance and light transparency, such as transparent glass or plastic.

The gate wire 21, 22 and the storage electrode wire 28, 29 are formed on the first insulating substrate 10, and the gate wire 21, 22 and the storage electrode wire 28, 29 may be formed in the same layer and arranged on the first insulating substrate 10. In exemplary embodiments, the gate wire 21, 22 and the storage electrode wire 28, 29 may be made of an aluminum (Al)-containing metal such as Al or Al alloy; a silver (Ag)-containing metal such as Ag or Ag alloy; a copper (Cu)-containing metal such as Cu or Cu alloy; a molybdenum (Mo)-containing metal such as Mo or Mo alloy; or a metallic material such as chromium (Cr), titanium (Ti) or tantalum (Ta). In addition, the gate wire 21, 22 and the storage electrode wire 28, 29 may include a multi-layered structure including two conductive films (not shown) having different physical characteristics.

In the exemplary embodiment, the gate wire 21, 22 includes a gate line 21 formed in a first direction on the first insulating substrate 10, and a gate electrode 22 formed on the gate line 21 in the form of a protrusion. The storage electrode wire 28, 29 applies a storage voltage and forms a storage capacitor together with the pixel electrode 81, which will be further described below.

Referring to FIGS. 1A to 2B, the gate line 21 is formed in the first direction, e.g., in a horizontal direction, on an insulating substrate 10, for transmitting gate signals, and the gate electrode 22 is formed on the gate line 21 and protrudes from the gate line 21. The gate electrode 22, and source and drain electrodes, which will be described below, constitute terminals of a TFT.

The storage electrode wire 28, 29 is overlapped by a portion of the pixel electrode 81 with an interlayer insulator interposed between the storage electrode wire 28, 29 and the portion of the pixel electrode 81, thereby maintaining a pixel voltage at a constant level. The storage electrode wire 28, 29 includes a storage electrode line 28 and a storage electrode 29. The storage electrode 29 may include a plurality of branches extending from the storage electrode line 28, or may include a protrusion protruding from the storage electrode line 28, and is relatively wider as compared to the storage electrode line 28. The storage electrode 29 is overlapped by a drain electrode extension 67. The storage electrode 29, the drain electrode extension 67, and the gate insulating layer 30, constitute a storage capacitor of a pixel.

The gate insulating layer 30, which is made of an insulating material such as silicon nitride (SiNₓ), is formed on the gate wire 21, 22 and the storage electrode wire 28, 29.

The semiconductor layer 40, which is made of hydrogenated amorphous silicon (“a-Si”) or polycrystalline silicon, is formed on the gate insulating layer 30. The semiconductor layer 40 may include various shapes such as an island shape or a stripe shape. In the illustrative embodiment, for example, the semiconductor layer 40 may be formed on the gate electrode 22 in an island shape. In an alternative exemplary embodiment, the semiconductor layer 40 may be formed in a stripe shape such that the semiconductor layer 40 is positioned below the drain electrode 66 and extends to or substantially toward the upper portion of the gate electrode 22. When the semiconductor layer 40 is formed in a stripe shape, the semiconductor layer 40 may be formed by patterning in substantially the same manner as the data line 62.

The ohmic contact layers 55 and 56, which are made using a material such as silicide or n+ hydrogenated a-Si doped with n-type impurities at a high concentration, are formed on the semiconductor layer 40. Here, the ohmic contact layers 55 and 56 improve electrical contact characteristics between the semiconductor layer 40 and the source and drain electrodes 65 and 66. Alternatively, when the electrical contact characteristics between the semiconductor layer 40 and the source and drain electrodes 65 and 66 are good or otherwise sufficient, the ohmic contact layers 55 and 56 may not be provided.

Exemplary embodiments of the ohmic contact layers 55 and 56 may include various shapes such as island shapes or stripe shapes. In the illustrative embodiment, when the ohmic contact layers 55 and 56 may be formed in, for example, an island shape, the ohmic contact layers 55 and 56 may be positioned under the drain electrode 66 and the source electrode 65. In alternative exemplary embodiments, when the ohmic contact layers 55 and 56 are formed in a stripe shape, the ohmic contact layers 55 and 56 may extend below the data line 62.

The data wire 62, 65, 66 are formed on the ohmic contact layers 55 and 56 and the gate insulating layer 30. The data wire 62, 65, 66 includes the data line 62, the source electrode 65 and the drain electrode 66.

Referring to FIGS. 1A to 2B, in an exemplary embodiment, the data line 62 extends in a second direction substantially perpendicular to the first direction, for example, in a longitudinal direction, and intersects the gate line 21. The data line 62 receives a data signal and transmits the data signal to the source electrode 65. The data line 62 may overlap a portion of the storage electrode wire 28, 29, and a width of the data line 62 may be less than a width of the storage electrode wire 28, 29.

The source electrode 65 is formed as a branch of the data line 62. One end of the source electrode 65 is coupled to the data line 62 and the other end thereof is positioned over the semiconductor layer 40 such that the source electrode 65 overlaps a portion of the semiconductor layer 40.

One end of the drain electrode 66 extends over the semiconductor layer 40 such that the drain electrode 66 overlaps with a portion of the semiconductor layer 40. The drain electrode 66 is separated by a predetermined gap from the source electrode 65 so as to face the source electrode 65 at an opposite side of the gate electrode 22.

The source electrode 65, the drain electrode 66, and the gate electrode 22, constitute a switching element. Accordingly, as a voltage is applied to the gate electrode 22, current flows through the source electrode 65 and the drain electrode 66.

In exemplary embodiments, the data wire 62, 65, 66 may include a single layer preferably made of Al, Cr, Mo, Ta, Ti or alloys thereof, or a multi-layered structure. In other words, the data wire 62, 65, 66 may be made of a refractory metal such as Cr, Mo, Ta, Ti or alloys thereof. However, the data wire 62, 65, 66 may have a multilayered structure including a refractory metal film (not shown) and a low resistivity film (not shown). Exemplary embodiments of the multi-layered structure include a double-layered structure including a lower Cr film and an upper Al film (Cr/Al), a lower Al film and an upper Mo film (Al/Mo), and a triple-layered structure of a lower Mo film, an intermediate Al film and an upper Mo film (Mo/Al/Mo). While particular embodiments are described, other materials and numbers of layers may alternatively be used for the data wire 62, 65, 66.

A passivation layer 70, which is made of an insulating layer, is formed on the data wire 62, 65, 66 and the exposed semiconductor layer 40. In an exemplary embodiment, the passivation layer 70 may be made of an inorganic insulating material such as silicon nitride or silicon oxide, a photosensitive organic material including good flatness characteristics, or a low dielectric insulating material such as a-Si:C:O and a-Si:O:F formed by plasma enhanced chemical vapor deposition (“PECVD”). When the passivation layer 70 is made of an organic insulating material, the passivation layer 70 may include a double-layered structure having a lower film made of an inorganic insulating material such as SiNₓ or silicon dioxide (SiO₂) and an upper film made of an organic insulating material in order to prevent the exposed portion of the semiconductor layer 40 from being damaged by the organic insulating material of the passivation layer 70.

The passivation layer 70 includes a contact hole 76 exposing the drain electrode 66.

The pixel electrode 81 is electrically connected to the drain electrode 66 via the contact hole 76 formed through the passivation layer 70. The R, G, and B color organic films 72R, 72G, 72B are formed on the passivation layer 70. The pixel electrode 81 extends substantially in the shape of a pixel and is positioned on the R, G, and B color organic films 72R, 72G, 72B.

The R, G, and B color organic films 72R, 72G, 72B determine colors of light transmitted to pixels representing three colors, red (R), green (G), and blue (B), although other colors are within the scope of these embodiments. In exemplary embodiments, the R, G, and B color organic films 72R, 72G, 72B may be formed by various methods such as a printing method using an inkjet printing apparatus, a gravure printing method, a screen printing method, a photolithography method, or the like.

As illustrated in FIGS. 1A, 1B, and 2A, the TFT panel 2 includes color organic films 72R, 72G, and 72B, which are patterned in a stripe shape. That is, the three-color organic films 72R, 72G, and 72B are repeatedly arranged in such a manner that the same color organic films are arranged in the same column, and color organic films in one of two adjacent columns have a different color from the color of the organic films in the other column. As such, when the color organic films 72R, 72G, and 72B are arranged in a stripe shape, two opposite sides of each pixel respectively contact different color organic films, and the other two opposite sides of each pixel respectively contact the same color organic films.

Arrangement of the color organic films 72R, 72G, and 72B in adjacent pixels will now be described in more detail with reference to FIGS. 2B and 2C.

First, an arrangement of the same color organic films in adjacent pixels will be described with reference to FIG. 2B. Referring to FIG. 2B, indentations 73a are formed between color organic films 72B corresponding to adjacent pixels. In the current exemplary embodiment, the indentations 73a refer to concave portions which are indented toward a first insulating substrate 10 by forming regions between adjacent pixels to a lower thickness than a thickness of color organic films corresponding to the adjacent pixels. In one exemplary embodiment, as illustrated in FIG. 2B, the indentations 73a may expose an underlying layer of the TFT array panel 2, such that adjacent color organic films 72B of the same color in a column direction are separated from each other.

In an exemplary embodiment, as illustrated in FIG. 2B, when the color organic films 72B corresponding to adjacent pixels are formed to be separated from each other by a predetermined distance, the indentations 73a may be defined toward the first insulating substrate 10 to a depth equal to or substantially similar to a height of the color organic films 72B.

As described above, when an indentation 73a is formed between two adjacent color organic films, impurities released from color organic films to a liquid crystal layer 4 (FIG. 2A) can be physically prevented or substantially reduced from freely passing through borders between the pixels.

In exemplary embodiments, two adjacent color organic films may be separated from each other by about 2 μm to about 8 μm. However, considering that the thickness of color organic films may be about 3 μm to about 5 μm, in an exemplary embodiment, two adjacent color organic films may be separated from each other by about 5 μm.

Moreover, indentations 73a as described above are not necessarily formed between the same color organic films. Thus, in exemplary embodiments, indentations 73a may also be formed between different color organic films.

Next, an arrangement of different color organic films in adjacent pixels will be described with reference to FIG. 2C. Referring to FIG. 2C, two adjacent color organic films 72R and 72B, such as formed in a row direction, are overlapped on data lines 62 to form protrusions 74. For the purpose of forming different color organic films, after a first color organic film is formed, second and third color organic films are sequentially formed. Therefore, according to the current exemplary embodiment of the present invention, it is easier to form the protrusions 74 by overlapping the two adjacent color organic films 72R and 72B. The protrusions 74 serve to prevent or substantially lessen a physical migration of impurities released from color organic films 72R, 72G, or 72B to a liquid crystal layer 4, like or substantially similar to the indentations 73a, as described above.

Referring again to FIGS. 1A, 1B, and 2A, the pixel electrode 81 adjusts a transmittance of pixels by adjusting a quantity of light emitted from the backlight assembly, thereby displaying images on the liquid crystal panel. The pixel electrode 81 is electrically connected to the drain electrode 66 via the contact hole 76. When data voltage is applied to the pixel electrode 81 via the drain electrode 66, the pixel electrode 81, together with the common electrode 140 of the common electrode panel 3, generates an electric field. The electric field induces an alignment of liquid crystal molecules within the liquid crystal layer 4 between the pixel electrode 81 and the common electrode 140.

Exemplary embodiments of the pixel electrode 81 may be formed of a transparent conductor such as indium tin oxide (“ITO”) or indium zinc oxide (“IZO”), or a reflective conductor such as Al, or the like.

In an exemplary embodiment, an alignment layer (not shown) capable of aligning liquid crystal molecules in the liquid crystal layer 4 may be disposed on the pixel electrode.

Hereinafter, the common electrode panel 3 will be described with reference to FIGS. 1A and 2A. The common electrode panel 3 includes a second insulating substrate 100, a black matrix 120, and the common electrode 140.

Exemplary embodiments of the second insulating substrate 100 may be formed of a material with heat resistance and light transparency, e.g., transparent glass or plastic. The black matrix 120 is disposed on the second insulating substrate 100 to define pixel areas.

The black matrix 120 serves to define pixel areas and to prevent or substantially reduce light leakage from other areas except the pixel areas. Exemplary embodiments of the black matrix 120 may be formed of metal (e.g., chromium), metal oxide (e.g., chromium oxide), organic black resist, or the like.

The common electrode 140 is formed on the second insulating substrate 100 and on the black matrix 120 using a transparent conductive material such as ITO or IZO.

The common electrode 140 serves as a counter electrode which is common to all liquid crystal cells. For this, ITO, or other transparent conductive material, may be deposited over an entire surface, or substantially an entire surface, of the common electrode panel 3.

Meanwhile, a spacer (not shown) may be disposed on the pixel electrodes 81 to uniformly maintain a gap between the common electrode panel 3 and the TFT panel 2. The liquid crystal layer 4 is formed in the space between the common electrode panel 3 and the TFT panel 2 which is defined by the spacer.

Hereinafter, a modified embodiment of the exemplary LCD 1 will be described with reference to FIG. 3 and FIG. 1A. FIG. 3 is a diagram illustrating a modified embodiment of FIG. 2B.

Referring to FIG. 3 and FIG. 1A, the same colors of color organic films 72R, 72G, and 72B are integrally formed in adjacent pixels, and trench-type indentations 73b are formed to a predetermined depth between the adjacent pixels. That is, the indentations 73b do not expose a layer of the TFT array panel 2 underlying the color organic films 72R, 72G, and 72B. Instead, the indentations 73b have a height that is less than a height of the color organic films 72R, 72G, and 72B.

In exemplary embodiments, the indentations 73b may be formed simultaneously with forming the color organic films 72R, 72G, and 72B. In alternative exemplary embodiments, the indentations 73b may be formed using a separate further process after forming the color organic films 72R, 72G, and 72B.

The formation of the color organic films 72R, 72G, and 72B may be achieved using various methods such as printing or photolithography, as described above. At this time, in order to form the indentations 73b in color organic film portions between adjacent pixels, the thickness of the color organic films 72R, 72G, and 72B may be adjusted.

In alternative exemplary embodiments, after forming precursor films for the color organic films 72R, 72G, and 72B to a predetermined thickness, the indentations 73b may be formed in the precursor films between adjacent pixels using a separate process. For example, when precursor films for the color organic films 72R, 72G, and 72B are formed to a predetermined thickness and precursor film portions between the adjacent pixels are pressed prior to curing, the indentations 73b having a predetermined depth and width are formed, and the resultant precursor films are heated or cured with ultraviolet (“UV”) light to form the color organic films 72R, 72G, and 72B. The above-described exemplary method is only intended as an illustration of an exemplary embodiment of how to form the trench-type indentations 73b in the color organic films 72R, 72G, and 72B. Thus, in alternative exemplary embodiments, the indentations 73b may also be formed using various other methods.

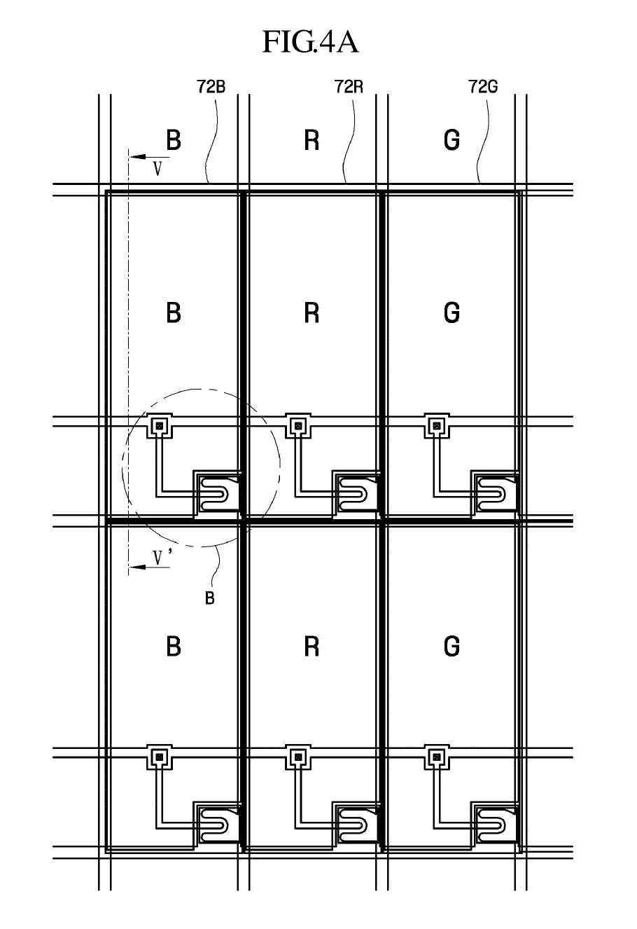

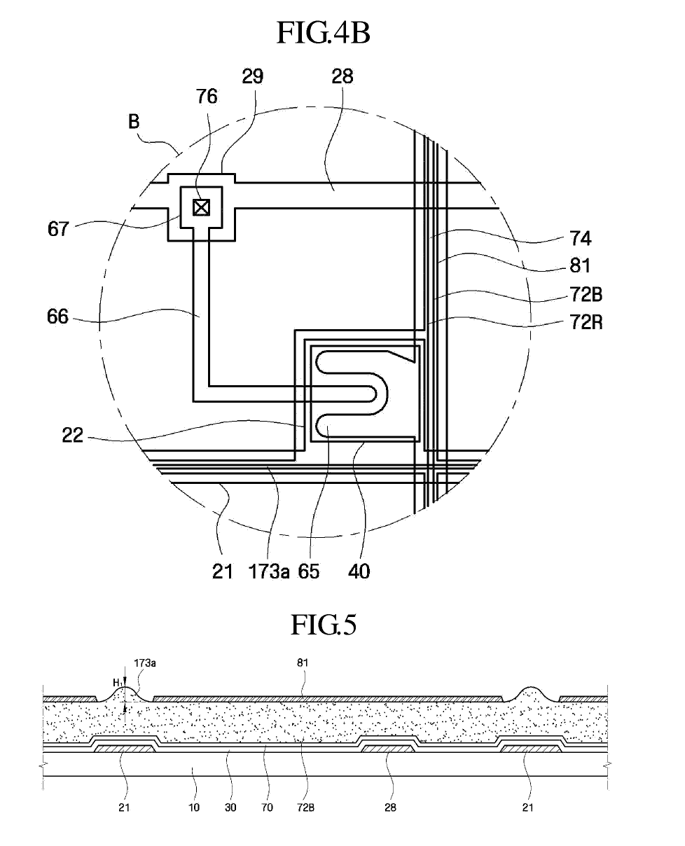

Hereinafter, an LCD according to a second exemplary embodiment of the present invention will now be described with reference to FIGS. 4A, 4B, and 5. FIG. 4A is a layout view illustrating an exemplary LCD according to a second exemplary embodiment of the present invention, FIG. 4 B is an enlarged partial view of part “B” of the exemplary LCD of FIG. 4A, and FIG. 5 is a sectional view taken along line V-V′ of the exemplary LCD of FIG. 4A. For convenience, components having the same or substantially same function as described in the first exemplary embodiment are respectively identified by the same reference numerals, and their repetitive description will be omitted. The exemplary LCD of the current exemplary embodiment of the present invention includes substantially the same structure as that of the first exemplary embodiment of the present invention except for differences described below, and as illustrated in FIGS. 4A, 4B, and 5.

That is, referring to FIGS. 4A, 4B, and 5, the exemplary LCD according to the second exemplary embodiment of the present invention includes protrusions 173a disposed between adjacent pixels corresponding to the same color organic films 72R, 72G, or 72B. While the protrusions 173a are shown between adjacent pixels corresponding to the blue organic films 72B, the protrusions 173a may also be formed between adjacent pixels corresponding to the red organic films 72R and between adjacent pixels corresponding to the green organic films 72G.

The protrusions 173a are formed between adjacent pixels corresponding to the same color organic films 72R, 72G, or 72B such that the protrusions 173a protrude beyond the color organic films 72R, 72G, or 72B in an opposite direction to the first insulating substrate 10. The protrusions 173a serve to physically prevent or substantially reduce migration of impurities released from color organic films 72R, 72G, or 72B to a liquid crystal layer 4, as described above.

Taking into consideration that the thickness of the color organic films 72R, 72G, and 72B is about 3 μm to about 5 μm, and a gap between the TFT array panel 2 and the common electrode panel 3 is about 4 μm to about 5 μm, the protrusions 173a may be formed to a height H₁ of about 0.5 μm to about 1.5 μm. However, the height H₁ of the protrusions 173a is only an exemplary embodiment according to the present invention. Thus, in alternative exemplary embodiments, the protrusions 173a may be formed to various heights considering the thickness of the color organic films 72R, 72G, and 72B and the thickness of the liquid crystal layer 4. The size of the formations between adjacent color organic films 72R, 72G, and 72B, whether the formations are indentations or protrusions, are therefore sized to prevent migration of impurities from the color organic films 72R, 72G, and 72B to the liquid crystal layer 4.

In exemplary embodiments, the protrusions 173a may be integrally formed using a printing plate (not shown) including grooves corresponding to the protrusions 173a. In alternative exemplary embodiments, the protrusions 173a may also be formed using a separate further process after forming the color organic films 72R, 72G, and 72B to the same thickness as a desired height of the protrusions 173a. The protrusions 173a do not necessarily need to be formed of the same material as the color organic films 72R, 72G, and 72B. In exemplary embodiments, the protrusions 173a may be formed of any material that includes a good adhesion property with respect to the color organic films 72R, 72G, and 72B to prevent or substantially reduce migration of impurities released from color organic films 72R, 72G, or 72B to a liquid crystal layer 4. Thus, the protrusions 173a may be formed to a predetermined height on the color organic films 72R, 72G, and 72B using various methods.

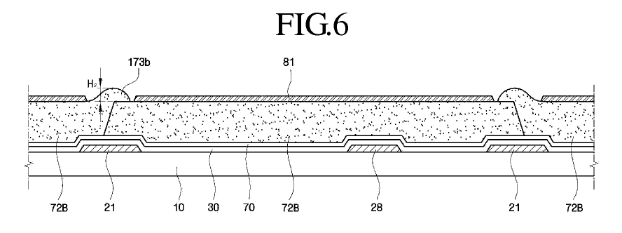

Hereinafter, a modified embodiment of the exemplary LCD according to the second exemplary embodiment of the present invention will be described with reference to FIG. 6 and FIG. 4A. FIG. 6 is a sectional view taken along line V-V′ of the exemplary LCD of FIG. 4A, according to a modified embodiment of FIG. 5.

Referring to FIG. 6 and FIG. 4A, the same color organic films 72R, 72G, or 72B corresponding to adjacent pixels are overlapped to form protrusions 173b. The same color organic films 72R, 72G, or 72B are generally formed using a single coating process, but in order to form the protrusions 173b, the organic films 72R, 72G, or 72B may also be formed by repeating the coating process twice or more. In an exemplary embodiment, the protrusions 173b are formed to a height H₂ of about 0.5 μm to about 1.5 μm.

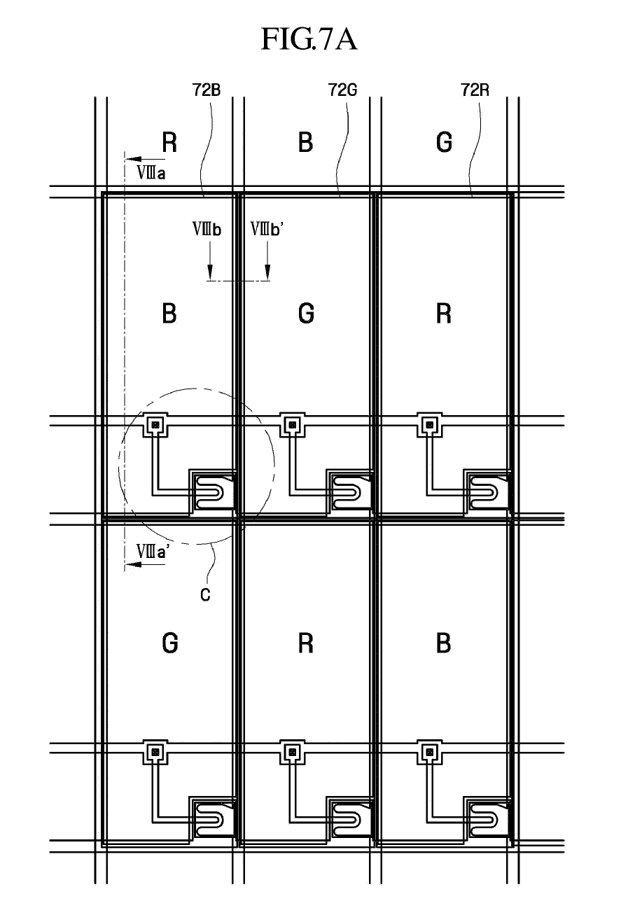

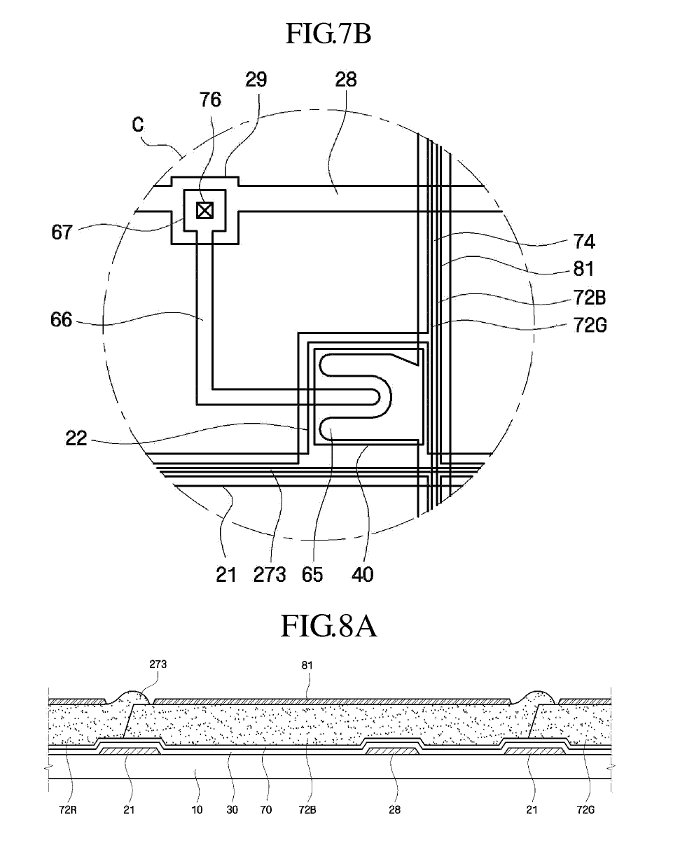

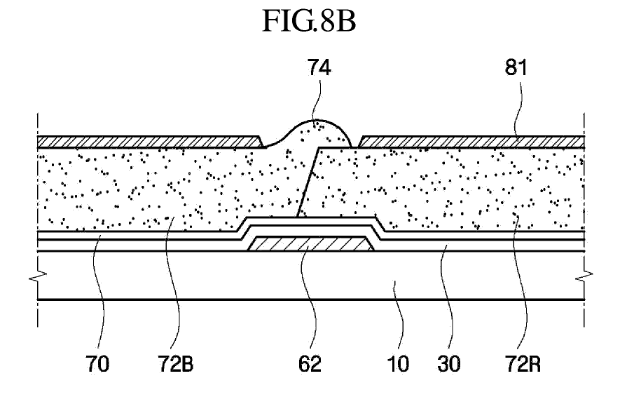

Hereinafter, an LCD according to a third exemplary embodiment of the present invention will be described with reference to FIGS. 7A through 8B. FIG. 7A is a layout view illustrating an exemplary LCD according to a third exemplary embodiment of the present invention, FIG. 7B is an enlarged partial view of part “C” of the exemplary LCD of FIG. 7A, and FIG. 8A is a sectional view taken along line VIIIa-VIIIa′ of the exemplary LCD of FIG. 7A.

For convenience, components having the same function or substantially the same function as described in the first exemplary embodiment are respectively identified by the same reference numerals, and their repetitive description will be omitted. The LCD of the current exemplary embodiment of the present invention includes substantially the same structure as that of the first exemplary embodiment of the present invention except for differences described below, and as illustrated in FIGS. 7A through 8B.

That is to say, according to the exemplary LCD of the third exemplary embodiment of the present invention, color organic films 72R, 72G, and 72B are arranged in a mosaic shape such that color organic films of adjacent pixels have different colors.

Referring to FIGS. 7A through 8B, color organic films 72R, 72G, and 72B of adjacent pixels are arranged to have different colors. Thus, the color organic films 72R, 72G, and 72B may be arranged to overlap each other to form protrusions 273.

As such, when the color organic films 72R, 72G, and 72B are arranged in a mosaic shape, a conventional process of sequentially forming different color organic films can be used after only a slight modification. Moreover, when the color organic films 72R, 72G, and 72B are overlapped, the manufacturing process is simplified and thus, process errors can be reduced, thereby improving an aperture ratio.

As described above, in LCDs according to exemplary embodiments of the present invention, migration of impurities in a liquid crystal layer can be prevented or at least substantially reduced by employing formations between adjacent color organic films, where each formation includes one of an indentation and a protrusion, thereby preventing or substantially reducing an occurrence of line afterimages that may be caused by the impurities.

While the present invention has been particularly shown and described with reference to some exemplary embodiments thereof, it will be understood by those of ordinary skill in the art that various changes in form and details may be made therein without departing from the spirit and scope of the present invention as defined by the following claims. It is therefore desired that the present embodiments be considered in all respects as illustrative and not restrictive, reference being made to the appended claims rather than the foregoing description to indicate the scope of the invention.

What is claimed is:

1. A liquid crystal display comprising:
gate lines and data lines intersecting on an insulating substrate;
pixels arranged in a matrix shape;
color organic films formed corresponding to the pixels; and
indentations formed between at least some adjacent color organic films.

2. The liquid crystal display of claim 1, wherein the indentations are formed by arranging at least some of the color organic films to be separated from each other.

3. The liquid crystal display of claim 1, wherein the indentations have a width of about 2 μm to about 8 μm.

4. The liquid crystal display of claim 1, wherein at least some of the adjacent color organic films are integrally formed on the insulating substrate and the indentations are formed in a trench shape between the at least some of the adjacent color organic films.

5. The liquid crystal display of claim 1, wherein the at least some of the adjacent color organic films are arranged on the insulating substrate along the data lines.

6. The liquid crystal display of claim 1, wherein the at least some of the adjacent color organic films include a same color.

7. The liquid crystal display of claim 1, wherein the indentations are arranged to overlap with the gate lines.

8. The liquid crystal display of claim 1, wherein the indentations are formed between color organic films adjacent to each other along the data lines, and further comprising protrusions formed between color organic films adjacent to each other along the gate lines.

9. The liquid crystal display of claim 8, wherein the color organic films adjacent to each other along the data lines have the same color, and the protrusions are formed between adjacent color organic films of different colors.

10. A liquid crystal display comprising:
gate lines and data lines intersecting on an insulating substrate;
pixels arranged in a matrix shape;
color organic films formed corresponding to the pixels; and
protrusions formed between adjacent color organic films arranged in a direction of the data lines, the protrusions overlapping with the gate lines.

11. The liquid crystal display of claim 10, wherein the color organic films are arranged to include different colors in a column-wise fashion, and the protrusions are formed between adjacent color organic films of different colors.

12. The liquid crystal display of claim 10, wherein the protrusions are formed between adjacent color organic films of a same color.

13. The liquid crystal display of claim 10, wherein the protrusions are integrally formed with the color organic films.

14. The liquid crystal display of claim 10, wherein the color organic films are arranged on the insulating substrate in a mosaic shape such that adjacent color organic films arranged in a direction of the data lines and arranged in a direction of the gate lines include different colors.

15. The liquid crystal display of claim 10, wherein the protrusions are formed by overlapping the adjacent color organic films.

16. The liquid crystal display of claim 10, wherein the protrusions include a height of about 0.5 μm to about 1.5 μm.

17. A liquid crystal display comprising:
gate lines and data lines intersecting on an insulating substrate;
pixels arranged in a matrix shape;
color organic films formed on the insulating substrate and corresponding to the pixels; and
formations disposed between adjacent color organic films, each of the formations including one of an indentation and a protrusion.

18. The liquid crystal display of claim 17, wherein the formations are sized to prevent migration of impurities from a pixel to an adjacent pixel.

19. A method of manufacturing a liquid crystal display, the method comprising:
forming gate lines and data lines intersecting on an insulating substrate;
arranging pixels in a matrix shape;
disposing color organic films on the insulating substrate and corresponding to the pixels; and
creating formations between adjacent color organic films to at least substantially prevent migration of impurities from a pixel to an adjacent pixel.

20. The method of claim 19, wherein creating formations includes creating indentations between adjacent color organic films.

21. The method of claim 19, wherein creating formations includes creating protrusions between adjacent color organic films.
